(19) United States
(12) Patent Application Publication
(10) Pub. No.: US 2017/0214664 A1
(43) Pub. Date: Jul. 27, 2017

(54) SECURE CONNECTIONS FOR LOW POWER DEVICES

(71) Applicant: Google Inc., Mountain View, CA (US)

(72) Inventors: Arnar Birgisson, San Francisco, CA (US); Bo Zhu, Sunnyvale, CA (US); Yevgeniy Gutnik, Cupertino, CA (US)

(21) Appl. No.: 15/413,762

(22) Filed: Jan. 24, 2017

Related U.S. Application Data
(60) Provisional application No. 62/287,226, filed on Jan. 26, 2016.

(51) Int. Cl. H04L 29/06; H04L 9/08; H04L 9/32

(52) U.S. Cl. CPC H04L 63/0428; H04L 9/3247; H04L 9/0869; H04L 2209/24

(57) ABSTRACT

The disclosed embodiments include computerized methods, systems, and devices, including computer programs encoded on a computer storage medium, for establishing secure wireless communications sessions involving low-power devices. A client device may discover a low-power resource device operating within a wireless network. Upon discovery, the client and resource devices may establish mutual randomness, and establish mutual possession of a shared cryptographic key. The resource device may, in some aspects, provide data proving its knowledge of an authentication tag of a local authentication token held confidentially by the client device. If the resource device proves its knowledge of the client device's authentication tag, the client and resource device may establish a secure communication session and generate session keys for subsequent communications.

### CROSS-REFERENCE TO RELATED APPLICATION

This application claims priority to U.S. Provisional Patent Application No. 62/287,226, filed on Jan. 26, 2016, the entire contents of which is incorporated by reference in its entirety.

### FIELD

This specification describes technologies related to wireless communications across low-power networks.

### BACKGROUND

Low-power devices, such as smart locks, smart appliances (e.g., washers, stoves, refrigerators, etc.), smart thermostats, and other devices capable of remote control, sensing, and operation, are increasing common and integrated into daily life. Due to relatively slow clock speeds associated with these devices, and limitations imposed on data transfer by the low-power networks on which they operate (e.g., such as Bluetooth™ low energy (BLE) networks), conventional protocols for secure connection and data encryption may be ineffective, thus rendering these devices vulnerable to attack by malicious parties.

### SUMMARY

The disclosed embodiments relate to computerized processes that establish secure and direct wireless connections across low-power networks (e.g., BLE networks) often utilized by smart locks, smart appliances (e.g., washers, stoves, refrigerators, etc.), smart thermostats, and other devices capable of remote operation and control. These computerized processes may establish connection protocols that obscure data exchanged during an initial handshake process from passive listeners, and that obscure data exchanged during subsequent authentication processes from not only passive listeners, but also from other validly authorized devices capable of eavesdropping on the connected devices.

For example, according to the disclosed connection protocols, a shared private cryptographic key may obscure device-specific data exchanged between a client device and a resource device during portions of the initial handshake process that establish mutual randomness and privacy, that enable the client device to verify an identity of the resource device, and that enable the client and resource devices to establish session keys to encrypt post-handshake communications. The generated session keys may, in some instances, obscure the post-handshake communications not only from passible listeners, but also from other devices capable of connecting to the resource device.

In some implementations, when establishing a new session between two devices, each of the devices sends the other random data (e.g., data that is random or psuedo-random). The devices can prove that they are authorized to communicate by applying a shared key on the random data provided by the other device. For example, without fully disclosing its identity, each device can prove its authorization by (i) using a shared symmetric key (e.g., a privacy key) to generate a signature for the received random data and (ii) providing the signature back to the device that sent the random data. Each device compares the signature it receives with a signature that the device generates for the random data it sent. A particular device can determine that communication is appropriate when the particular device determines that the received signature matches the generated signature (e.g., for the random data that the particular device sent). Having established an initial measure of privacy or trust, the two devices may perform additional authentication steps, and ultimately each can generate a session key that is session-specific and known only to the two devices. For example, the session key may be generated based on an authentication token of one of the devices, the random data exchanged by the devices for the session, and the shared symmetric key.

The techniques described herein may provide one or more of the following advantages. For example, the security of communications sessions between devices can be enhanced. When two devices initiate a communication session, the devices can establish privacy and perform a level of authentication in order to generate a new session key that serves as a new secret for both devices. For example, when a session is initiated, each device can send a small amount of random data (e.g., 12 bytes, 30 bytes, etc.) to the other device. The devices can then prove to each other that they share a particular symmetric cryptographic key by using the key on the received random data and providing the resulting signature. For low-power devices, e.g., devices that are or have limited computational capacity, public key or asymmetric cryptography may be too slow, too computationally demanding, or too power-intensive in some instances. On the other hand, when using symmetric key cryptography, it is necessary to avoid sending data that could be used in replay attacks. By sending random data and signatures generated from the random data, a device can verify that the other device has a shared cryptographic key without revealing the symmetric key. The random data and signatures that are exchanged while authenticating to begin a session are specific to that session, and would not allow an eavesdropper to create an unauthorized session with that information. In addition, the techniques discussed herein can enable devices to separately generate identical session keys that are used for a single communication session. The session key need not be transmitted since the processes disclosed herein enable both the devices to generate the session key.

In an embodiment, a computer-implemented method includes transmitting, by one or more processors of a client device, first random data to a resource device across a direct wireless connection. The method also includes receiving, by the one or more processors, a first digital signature from the resource device. The first digital signature may be computed by the resource device based on the first random data and the first cryptographic key. The method also computes, by the one or more processors, a second digital signature based on the first random data, and determines, by the one or more processors, that the first digital signature corresponds to the second digital signature. In response to the determination, the method generates, by the one or more processors, a session key associated with a communications session between the client and resource devices.

In some aspects, the disclosed methods may include receiving second random data from the resource device. The method may also include encrypting token data using a first cryptographic key, and transmitting the encrypted token data to the resource device across the direct wireless connection. The token data may include at least a portion of an authentication token maintained by the client device, and the first cryptographic key may be shared between the client and resource devices. The token data may also include an identifier of a second cryptographic key, the second cryptographic key may be specific to and maintained confidentially by the client device. In other aspects, the authentication token may include a macaroon, the macaroon including one or more caveats and a corresponding key, and the token data including at least one of the caveats. At least one of the caveats may include an identifier of a second cryptographic key, the second cryptographic key may be specific to and maintained confidentially by the client device. Furthermore, the session key may be computed based on the at least one caveat and the second digital signature. Additionally, the methods may generate a third cryptographic key in accordance with a key rotation schedule, and encrypt the token data using the third cryptographic key. In further aspects, the methods may include receiving the first cryptographic key from at least one of the resource device or an additional computing system.

In other aspects, the disclosed methods may include generating a cryptographic hash of the token data and transmitting the cryptographic hash to the resource device. The methods may also include determining that the encrypted token data exceeds a threshold message size, and in response to the determination, generating the cryptographic hash of the token data. The methods may also generate the first random data. Furthermore, the disclosed methods for computing the second digital signature may include calculating a message authentication code of the first random data. The message authentication code may, for example, include a hash-based message authentication code. In some instances, the disclosed method may verify an identity of the resource device in response to the determination that the first digital signature matches the second digital signature. Further, the disclosed methods for computing session key may include computing the session key based on at least a portion of the token data and the second digital signature. In some instances, the resource device may compute the first digital signature based on the first random data, the first cryptographic key, and a root cryptographic key maintained by the resource device. In some implementations, the disclosed methods include using the session key during the communications session to (i) encrypt data from the client device that is sent to the resource device and (ii) decrypt data from the resource device that is sent to the client device.

In further embodiments, a computer-implemented method includes receiving, by one or more processors of a resource device, first random data and encrypted token data from a client device across a direct wireless connection. The method also includes decrypting, by the one or more processors, the encrypted token data using a first cryptographic key. The first cryptographic key may be shared between the client and resource devices, and the token data may include at least a portion of an authentication token maintained by the client device. The method computes, by the one or more processors, a digital signature for the first random data. The digital signature may be computed based on at least a portion of the decrypted token data and the first cryptographic key. The method also includes transmitting, by the one or more processors, data comprising the computed digital signature to the client device across the wireless connection; and generating, by the one or more processors, a session key associated with a communications session between the client and resource devices.

In certain aspects, the client device is configured to establish the communication session based on a correspondence between the computed digital signature and an additional digital signature computed by the client device for the first random data. Further, the disclosed methods may also generate the session key based on at least a portion of the decrypted token data and the computed digital signature. The disclosed methods may additionally include receiving a cryptographic hash of the token data, determining that the received cryptographic hash is invalid, generating an error message indicative of the invalid hash, and transmitting the error message to the client device. The disclosed methods may also transmit second random data to the client device. In additional aspect, the method may include encrypting an identifier of the resource device using the first cryptographic key, and transmitting the encrypted identifier to the client device. The disclosed methods may compute the digital signature comprises calculating a message authentication code of the first random data, and the message authentication code comprises a hash-based message authentication code.

In further aspects, the authentication token may include a macaroon, the macaroon may include one or more caveats and a corresponding key, and the token data may include at least one of the caveats. At least one of the caveats may include an identifier of a second cryptographic key, the second cryptographic key being specific to and maintained confidentially by the client device. The disclosed methods may compute the digital signature based on the root key and the at least one caveat, and further, may generate the root key. Additionally, the disclosed methods may generate the first cryptographic key based on the root key, and transmit the first cryptographic key to the client device. Further, in some aspects, the disclosed methods may compute the digital signature based on a root key maintained by the resource device, the first cryptographic key, and the at least one caveat. In some implementations, the disclosed methods include using the session key during the communications session to (i) decrypt data from the client device that is sent to the resource device and (ii) encrypt data from the resource device that is sent to the client device.

In other embodiments, corresponding systems, devices, and computer programs, may be configured to perform the actions of the methods, encoded on computer storage devices. A device having one or more processors may be so configured by virtue of software, firmware, hardware, or a combination of them installed on the device that in operation cause the device to perform the actions. One or more computer programs can be so configured by virtue of having instructions that, when executed by device, cause the device to perform the actions.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 is a diagram of an exemplary computing system, consistent with the disclosed embodiments.

FIG. 2 is a diagram illustrating an exchange of data by devices implementing an exemplary connection protocol, consistent with the disclosed embodiments.

FIGS. 3 and 4 are flowcharts of exemplary processes for establishing secure and direct wireless connection between devices across a low-energy communications network, consistent with the disclosed embodiments.

Like reference numbers and designations in the various drawings indicate like elements.

### DETAILED DESCRIPTION

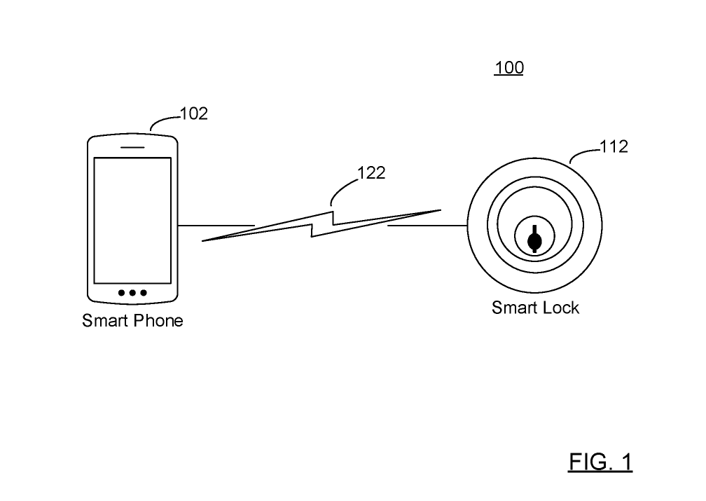

FIG. 1 illustrates an exemplary system 100 for establishing and maintaining secured wireless connections between various devices, including devices operated by low-power microcontroller units (MCUs) and systems-on-chip (SoCs). System 100 may, for example, include a client device 102, a resource device 112, and a communications network 122 capable of directly connecting client device 102 and resource device 112. Connection protocols consistent with the disclosed embodiments may enable client device 102 and resource device 112 to establish and maintain secured, encrypted communications across network 122.

Client device 102 may include, but is not limited to, a mobile telephone, a smart phone, a tablet computer, a desktop computer, laptop computer, a tablet computer, a wearable computer, a music player, an e-book reader, a navigation system, or any other appropriate computing device capable establishing communications with resource device 112 and additionally or alternatively, other devices, computer systems, and server systems, across communications network 122. Further, in certain aspects, network 122 may include a wireless personal area network (PAN), such as a Bluetooth™ low energy (BLE) network. In other aspects, and consistent with the disclosed embodiments, network 122 may include, but is not limited to, a wireless local area network (LAN), e.g., a “Wi-Fi” network, a RF network, a Near Field Communication (NFC) network, a wireless Metropolitan Area Network (MAN) connecting multiple wireless LANs, and a wide area network (WAN), e.g., the Internet.

Resource device 112 may, in some aspects, include a low-power device (e.g., operated by a low-power microcontroller unit (MCU) and/or a system-on-chip (SoC)), which may be configured to establish communications with client device 102 across network 122. By way of example, resource device 122 may include, but is not limited to, a set of wireless speakers, a wireless printer or other electronic device, a smart lock, a smart appliance (e.g., a refrigerator, stove, and/or washer), a smart thermostat or other sensor, and any additional or alternate device (e.g., an Internet-of-Things (IOT) connected device) capable of establishing communications with client device 102 across network 122. In some implementations, the resource device is a “server” device according to the Weave or μWeave protocols.

In some aspects, client device 102 and resource device 112 may implement one or more connection protocols to establish a secure, direct wireless connection across network 122 and to exchange encrypted communications across the established wireless connection. By way of example, conventional connection protocols may rely on asymmetric cryptographic operations to authenticate resource device 112 (and/or client device 102) and to establish session keys. As described above, however, resource device 112 may include devices operated by low-power MCUs and SoCs. These low-power MCUs and/or SoCs operate at relatively low clock speeds, which may render them incapable of performing asymmetric cryptographic operations at speeds sufficient to process and authenticate individual connection requests (e.g., from client device 102 or from other client devices in system 100). In view of the limitations imposed by the low-power MCUs and/or SoCs, connection protocols consistent with the disclosed embodiments may rely on symmetric primitives to establish secured wireless connections between client device 102 and resource device 112.

By way of example, processes that establish secured wireless connections between client device 102 and resource device 112 may include: (i) an initial “handshake” phase by which client device 102 establishes a privacy boundary, verifies an identity of resource device 112, and establishes session keys jointly with resource device 112; and (ii) a subsequent authentication phase by which resource device 112 authenticates client device 102 (and additionally or alternatively, a user of client device 102) and/or verifies an ability of client device 102 to access one or more functions of resource device 112 (e.g., as delegated by an owner of resource device 112). Connection protocols consistent with the disclosed embodiments may, among other things, may utilize a shared private key to mask communications between client device 102 and resource device 112 during the initial handshake phase, and a generated session key (e.g., held confidentially by client device 102 and resource device 112) to mask communications between client device 102 and resource device 112 during the subsequent authentication phase.

To implement these and other connection protocols, client device 102 and resource device 112 may be configured to receive, generate, and/or store one or more cryptographic keys and authentication tokens. By way of example, and consistent with the disclosed embodiments, resource device 112 may generate and store a root cryptographic key and a root device authentication token. In some aspects, described herein, resource device 112 may process the root cryptographic key to generate client-specific digital signatures based on received caveat data and thus, prove its knowledge of a corresponding client-specific key to client device 102. As discussed further below, caveats can be message blocks or predicates that are components of an authentication token. An authentication token, such as a macaroon can begin with an initial component, generated by a server system, and the initial component may be based on a secret initialization vector and a random nonce. Caveats can then be added as successive message blocks. For example, each new caveat can be generated from the most recently added message block and information about the new caveat. In this manner, each caveat depends on each of the previous caveats. Caveats may associate restrictions, identifiers, keys, or other information to a token. Generally, the requirements indicated by each caveat must be satisfied for the token to authorize access.

In further aspects, described resource device 112 and/or other devices operating in system 100 (e.g., client device 102, other client devices, other computing systems, such as cloud servers, etc.) may derive one or more local server access tokens based on the generated root device authentication token. Resource device 112 may, for example, generate the root cryptographic key and/or the root device authentication token during an initial device setup and pairing process (e.g., with a device of an owner, which may include client device 102).

Additionally, client device 102 and resource device 112 may store local copies of the shared private cryptographic key, which may encrypt communications between client device 102 and resource device 112 during the initial handshake phase and thus obscure any device-specific information from a passive listener. In certain aspects, the shared private cryptographic key may be generated by resource device 112 using the stored root cryptographic key, and resource device 112 may provide the shared private cryptographic key to client device 102 across network 122. In other aspects, resource device 112 may provide the shared private cryptographic key to an additional device (e.g., a device held by an owner of resource device 112) and/or to an additional computing system (e.g., a cloud server, such as a server maintained by Google Cloud™) during an initial registration and/or bootstrapping process. The additional device and/or computing system may then provide the shared private cryptographic key to client device 102 as a portion of one or more authentication tokens, such as those described below.

The disclosed embodiments may also establish a private network that includes resource device 112 and client device 102. In some implementations, the private network is limited to the resource device 112 and the client device 102. Alternatively, other client devices operating within system 100 may be capable of establishing secured connections with resource device 112 on the same private network. In some aspects, the devices within the established private network may each receive and/or store locally a copy of the shared private cryptographic key (e.g., using any of the exemplary processes described above). Thus, although an encryption of communications between client device 102 and resource device 112 using the shared private cryptographic key may obscure device-specific information from a passive listener outside of the private network, any device operating within the private network may obtain device-specific information from exchanged communications.

Client device 102 may also store copies of a local device authentication token and a local client authentication token. For example, using the local device authentication token, client device 102 may verify an identity of resource device 112 (e.g., that client device 102 is establishing a connection with the correct device) and ensure that no attacker or malicious party attempts a man-in-the-middle attack. In other instances, the local client authentication token may include data identifying one or more restrictions on an ability of client device 102 to access functions of resource device 112 (e.g., role-based, temporal, and/or session-based restrictions). By way of example, and after completing the initial handshake phase, client device 102 may present portions of the local client authentication token to resource device 112 in an effort to access various functions of resource device 112. In certain aspects, client device 102 may receive the local device authentication token and/or the local client authentication token from an additional device (e.g., a device held by an owner of resource device 112) and/or from an additional computing system (e.g., a cloud server, such as a server maintain by Google Cloud™) operating within system 100 (not shown in FIG. 1).

In some aspects, authentication tokens consistent with the disclosed embodiments (e.g., the local client authentication token, the root device authentication token, and/or local device authentication token) may be formatted as macaroons, which include a sequence of byte-strings (e.g., caveats) and an authentication tag (e.g., a digital signature) computed recursively by applying a message authentication code (MAC) algorithm to each caveat in a nested fashion. The caveats may, in some aspects, include identifiers of client-specific cryptographic keys, data identifying valid communications sessions, temporal restrictions, and/or local access restrictions imposed on client device 102, e.g., by an owner of resource device 112. Further, in additional aspects, a macaroon may be extended (e.g., by client device 102, by resource device 112, and/or by an additional computing system (e.g., a cloud service)) by adding additional caveats and by recursively applying the MAC algorithm to the additional caveats using the previous tag as the key. Additionally, MAC algorithms consistent with the disclosed embodiments may include, but are not limited to, an HMAC-SHA256 algorithm with a tag length of sixteen bytes and other algorithms appropriate with the client device 102, resource device 112, and network 122.

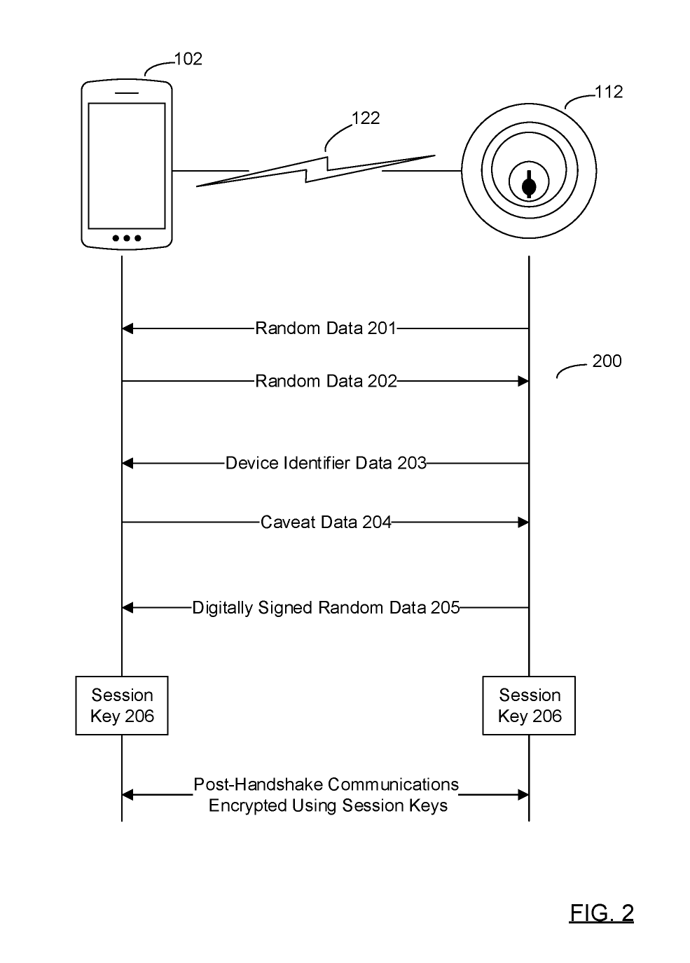

Using the stored cryptographic keys and authentication tokens, the disclosed embodiments may enable client device 102 and resource device 112 to establish a secure and direct wireless connection across network 122 in a manner that obscures data exchanged during the initial handshake process from passive listeners, and that obscures data exchanged during the subsequent authentication process from not only passive listeners, but also from other devices of an established private network. For example, as described below in reference to FIG. 2, the shared private cryptographic key may obscure device-specific data exchanged between client device 102 and resource device 112 during portions of the initial handshake process that establish mutual randomness and privacy, that enable client device 102 to verify an identity of resource device 112, and that enable client device 102 and resource device 112 to establish session keys.

FIG. 2 is a schematic diagram illustrating an exemplary exchange of data 200 during an initial handshake process of a symmetric-key connection protocol, in accordance with disclosed embodiments. For instance, resource device 112 may be discoverable to devices operating across network 122, and may broadcast advertisement data indicative of its discoverable state to devices operating across network 122. In other instances, resource device 122 may be privately discoverable, and may include ephemeral identifier (EID) data within the advertisement data to indicate its membership in one or more private networks operating within system 100.

In one example, network 122 may include a BLE network, and resource device 112 may, when privately discoverable, broadcast advertisement data that includes a random number of specified length (e.g., a 16-bit random number) and a digital signature of that random number generated using the shared private cryptographic key (e.g., using any of the MAC algorithms described above). Client device 102 may receive advertisement data, generate an additional digital signature of the random number using the shared private cryptographic key, and discover resource device 112 when the received and generated digital signatures match.

Upon discovery of resource device 112 by client device 102, client device 102 and resource device 112 may initiate processes to establish a secure, direct connection across network 122 by establishing mutual randomness between client device 102 and resource device 112. For example, as illustrated in FIG. 2, resource device 112 may generate random data 201, and transmit random data 201 to client device 102 across network 122. Client device 102 may receive and store random data 201 in a locally accessible memory or data repository, and may generate random data 202. Further, client device 102 may transmit random data 202 across network 122 to resource device 112, which may store random data 202 in a corresponding locally accessible memory or data repository.

The disclosed connection protocols may, in some instances, specify an amount of data included within random data 201 and 202 (e.g., twelve bytes, etc.), and client device 102 and resource device 112 may generate respective random data 201 and 202 using any appropriate algorithm. The establishment of mutual randomness by client device 102 and resource device 112 may, in some aspects, reduce a likelihood or replay attacks (e.g., when a malicious party monitors and attempts to replicate the initial handshake process). Further, by establishing randomness between client device 102 and resource device 112, the disclosed embodiments ensure a “freshness” of random data 201 and 202 (e.g., that the data is new and not previously intercepted) and further, ensure that a potentially malicious entity cannot break the freshness of random data 201 and 202. As used herein, the term “random data” refers to data that is random or pseudo-random. The random data may be generated by any of various techniques to obtain data that varies from one session to the next is not predictable by an observer.

In response to establishing mutual randomness (e.g., each device 102, 112 obtaining random data provided by the other device), client device 102 and resource device 112 may perform processes that establish privacy and their mutual possession of the shared private cryptographic key. For example, resource device 112 may access its local copy of the shared private cryptographic key, and may encrypt a device identifier (e.g., a media access control (MAC) address, an IP address, etc.). Resource device 112 may transmit the encrypted device identifier (e.g., device identifier data 203 of FIG. 2) across network 122 to client device 102, which may decrypt device identifier data 203 and store the device identifier in a locally accessible memory or data repository.

The disclosed embodiments are, however, not limited to processes in which resource device 112 encrypts device identifier data 203 (e.g., using the shared private cryptographic key) prior to transmission to client device 102. In other aspects, and consistent with the disclosed embodiments, resource device 112 may trust the transport mechanism associated with network 122, and may transmit device identifier data 203 to client device 102 across network 122 without encryption. Client device 102 may receive device identifier data 203 in unencrypted form, and may store the device identifier using any of the exemplary techniques described above.

Further, and as described above, client device 102 may store a local device authentication token that, in macaroon form, may include a sequence of caveats and an authorization key. Client device 102 also maintains a client-specific cryptographic key (e.g., known only to client device 102 and resource device 112), and at least one of the caveats may include an identifier of the client-specific cryptographic key. In some instances, client device 102 may access and encrypt the sequence of caveats using its local copy of the shared private cryptographic key, and may transmit the encrypted caveat data (e.g., caveat data 204) to resource device 112 across network 122.

Resource device 112 may receive caveat data 204, and resource device 112 may decrypt the caveat data 204 to identify the sequence of caveats included within client device 102's local device authentication token. Resource device 112 may also store the identified caveats within the locally accessible memory or data repository. In certain aspects, as described above, at least one of the caveats may include the identifier of the client-specific cryptographic key, which resource device 112 may extract from the decrypted sequence of caveats and store in the locally accessible memory or data repository.

The disclosed embodiments are not limited to processes that encrypt caveat data 204 (e.g., using the shared private cryptographic key) prior to transmission to resource device 112. In other aspects, and consistent with the disclosed embodiments, client device 102 may transmit caveat data 204 to resource device 112 across network 122 without encryption (e.g., client device 102 may trust the transport mechanism associated with network 122). Resource device 112 may receive caveat data 204 in unencrypted form, and may identify and store the sequence of caveats using any of the exemplary techniques described above.

In certain aspects, the exchange of the encrypted device identifier data and caveat data across network 122 may enable client device 102 and resource device 112 to mutually establish their possession of the shared private cryptographic key. Further, while device discovery processes in low-bandwidth networks (e.g., the BLE network described above) may not broadcast a complete device identifier of resource device 112, connection protocols consistent with the disclosed embodiments allow client device 102 to receive a complete device identifier of resource device 112 (e.g., via device identifier data 203), and enable resource device 112 to identify the sequence of caveats of the local device authentication token that will authenticate client device 102 after completion of the initial handshake phase (e.g., via caveat data 204).

In further aspects, connection protocols consistent with the disclosed embodiments may enable client device 102 to establish resource device 112's knowledge of the client-specific cryptographic key, and thus enable client device 102 to verify an identity of resource device 112. For instance, upon establishing its possession of the shared private cryptographic key, resource device 112 may apply a client-specific digital signature to random data 202 (e.g., as received from client device 102), and may transmit the signed random data (e.g., digitally signed random data 205) to client device 102 across network 122. In some instances, resource device 112 may derive a copy of the client-specific cryptographic key from the generated root cryptographic key and the sequence of caveats received from client device 102 (e.g., and stored in locally accessible memory or data repository), and may compute the client-specific digital signature by applying a MAC algorithm to random data 202 (e.g., as received from client device 102), with the derived copy serving as the key for the digital signature. Further, as described above, MAC algorithms consistent with the disclosed embodiments may include, but are not limited to, an HMAC-SHA256 algorithm with a tag length of 16 bytes.

Client device 102 may receive digitally signed random data 205 from resource device 112, and may then compute a digital signature of the random data 202 (e.g., as generated by client device 102) using the MAC algorithm and the client-specific cryptographic key. In some aspects, client device 102 may compare the received digital signature (e.g., as obtained from signed random data 205) with the computed digital signature. If the computed and received digital signatures fail to match, client device 102 may determine that resource device 112 did not prove its possession of the client-specific cryptographic key, and client device 102 may transmit a message indicative of a failed connection to resource device 112.

If, however, client device 102 were to detect a match between computed and received digital signatures, client device 102 may establish that resource device 112 proved its possession of the client-specific cryptographic key (e.g., and the tag of client device 102's local device authentication token) and thus, client device 102 may authenticate an identity of resource device 112. In certain aspects, the disclosed connection protocols may enable resource device 112 to prove its knowledge of client-specific cryptographic key to client device 102 without actually storing the client-specific cryptographic key in local memory.

Once resource device 112 provides the requisite proof, and client device 102 verifies an identity of resource device 112, client device 102 and resource device 112 may each compute copies of a session key 206 for the direct wireless connection between client device 102 and resource device 112 (e.g., across the BLE network described above). The client device 102 and the resource device 112 may each separately generate the same session key 206. Session key 206 may, for example, be computed based on an application of a key derivation function to the shared private cryptographic key, the tag of the local device authentication token, and the caveat sequence, which are known and/or stored by client device 102 and resource device 112. In some implementations, the random data 201, 202 and/or other values may be used in the key derivation function. In an embodiment, client device 102 and resource device 112 maintain the confidentiality of these generated session keys.

Further, and upon generation of the session keys by client device 102 and resource device 112, the initial handshake phase of disclosed connection protocols is complete. In some embodiments, data exchanged between client device 102 and resource device 112 across the established secure connection may be encrypted using the generated session keys, including data provided to resource device 112 to authenticate client device 102 and additionally or alternatively, to provide client device 102 with access to one or more functions of resource device 112 (e.g., portions of the local client authentication token).

Additionally, in certain embodiments, the generated session keys (e.g., session keys 206) may impose an upper limit on a number of messages exchanged by client device 102 resource device 112 (e.g., 2³¹ messages). If a number of messages encrypted using the session keys and transmitted by client device 102 and/or resource device 112 were to reach this upper limit, the disclosed connection protocols specify that a corresponding one of client device 102 and/or resource device 112 tear down the established secure, direct connection and establish a new connection using any of the exemplary processes described herein.

Further, as described above in reference to FIG. 2, data exchanged between client device 102 and resource device 112 may enable client device 102 to verify a mutual possession of the shared private cryptographic key by client device 102 and resource device 112, and further, to verify resource device 112's knowledge of a client-specific cryptographic key (and thus, a tag of a local device authentication token maintained by client device 102). In certain aspects, however, network 122 may include a low-power transport mechanism that imposes a maximum transmission unit (MTU) on any data exchanged between client device 102 and resource device 112. For example, and as described above, client device 102 and resource device 112 may exchange data across a Bluetooth198 low energy (BLE) network, which may impose a MTU of nineteen bytes on any message exchanged between client device 102 and resource device 112.

In one embodiment, one or more of the messages exchanged between client device 102 and resource device 112 (e.g., as described in reference to FIG. 2) may exceed the nineteen-byte MTU imposed by the low-power BLE network. For example, as described above, client device 102 may transmit an encrypted sequence of caveats (e.g., caveat data 204) to resource device in partial proof that client device 102 and resource device 112 both possess the shared private cryptographic key. Depending on a number of caveats and/or an amount of data in the caveats, the encrypted caveat data may exceed the imposed nineteen-byte MTU, and the disclosed connection protocols may enable client device 102 to transmit a truncated cryptographic hash of the sequence of caveats to resource device 112 in place of the encrypted caveat data. By way of example, client device 102 may compute the cryptographic hash of the caveat sequence using a SHA-256 hash algorithm and the shared private cryptographic key, and may truncate a size of the computed cryptographic hash below the MTU (e.g., sixteen bytes).

Resource device 102 may receive the truncated hash of the caveat sequence, and if resource device 112 recognizes the truncated cryptographic hash, resource device 112 may establish the mutual possession of the shared private cryptographic key by client device 102 and resource device 112, as described above. Resource device 112 may then apply a client-specific digital signature to received random data 202 (e.g., as received from client device 102), and may transmit the signed random data (e.g., digitally signed random data 205) to client device 102 across network 122 using any of the exemplary processes described above. If, however, resource device 112 were unable to recognize the truncated cryptographic hash, resource device 112 may respond to client device 102's transmission with a message indicating failure and requesting that client device 102 transmit the encrypted caveat data, including the full caveat sequence, to resource device 112 using any of the exemplary processes described above.

Further, one or more of the disclosed connection protocols may rely on the shared private cryptographic key to obscure the identity of resource device 112 (e.g. through the encrypted device identifier) and client device 102 (e.g., through the encrypted caveat sequence) from passive listeners. The disclosed embodiments are, however, not limited to these exemplary shared private cryptographic key, and in further embodiments, client device 102 and resource device 112 may obscure their identities from passive listeners using other cryptographic schemes. For example, and without limitation, client device 102 and resource device 112 may rely on cryptographic keys regularly discarded and re-generated in accordance with a rotational key generation algorithm appropriate to client device 102 and resource device 112.

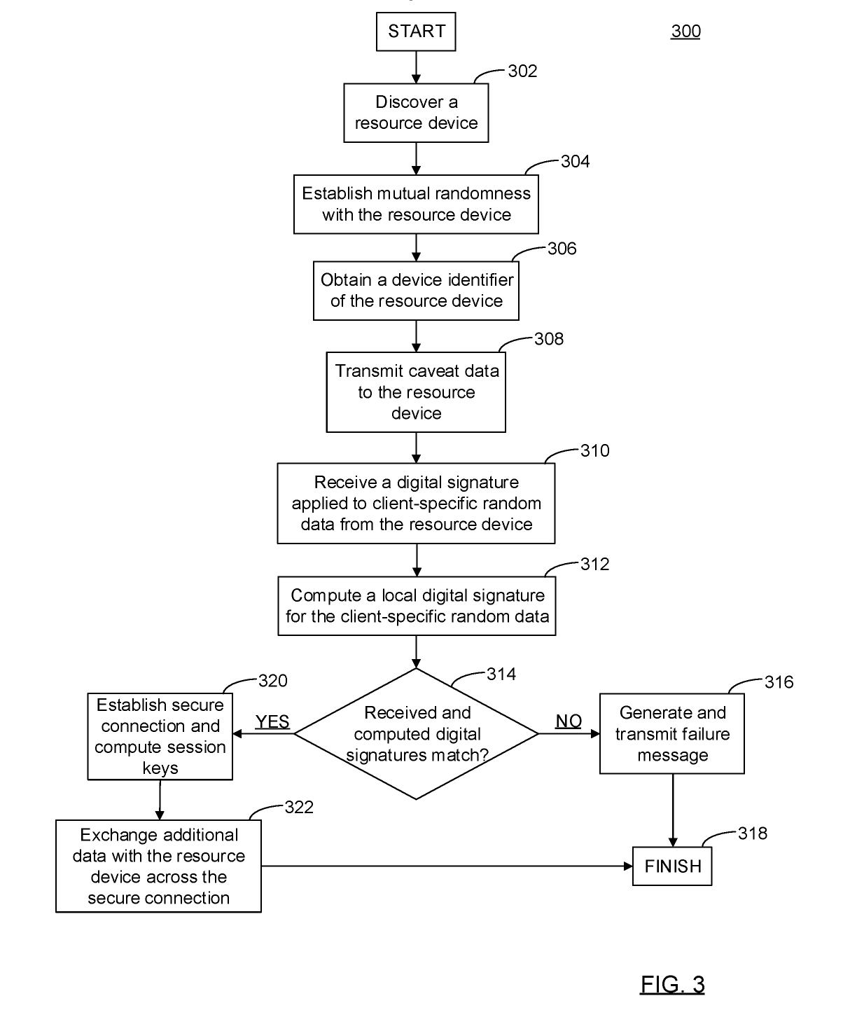

FIG. 3 is a flowchart of an exemplary process 300 for establishing a secure and direct wireless connection between client and resource devices across a low-energy communications network, in accordance with the disclosed embodiments. In certain aspects, a client device (e.g., client device 102 of FIG. 1) may perform the steps of exemplary process 300, which may enable client device 102 to discover a resource device (e.g., resource device 112) operating across a low-energy communication network (e.g., network 122) and to establish a secure wireless connection with resource device 122 across network 122 using connection protocols consistent with the disclosed embodiments.

In some aspects, client device 102 may perform operations that discover resource device 112 operating across network 122 (e.g., in step 302). By way of example, and as described above, resource device 112 may broadcast data advertising its discoverable state to other devices operating across network 122. In certain instances, resource device 112 may be publicly discoverable, and the advertisement data may include, but is not limited to, data identifying resource device 112 (e.g., a device identifier, etc.). In other instances, resource device 112 may be privately discoverable, and the advertisement data may include ephemeral identifier (EID) data indicative of resource device 112's membership in one or more private networks. For example, when privately discoverable, resource device 112 may generate and broadcast advertisement data that includes a random number (e.g., a 16-bit random number) and a digital signature of that random number generated using a private cryptographic key shared among members of at least one of the private networks (e.g., the shared private cryptographic key as described above).

In step 302, client device 102 may receive the advertisement data broadcast by resource device 112, extract the received random number and digital signature from the received advertisement data, and generate an additional digital signature of the random number using the shared private cryptographic key. Client device 102 may, in some aspects, discover resource device 112 across network 122 when the received digital signature matches the additional digital signature generated by client device 102.

Upon discovery of resource device 112, client device 102 may establish mutual randomness with newly discovered resource device 112. For example, in step 304, client device 102 may receive device-specific random data from resource device 112 (e.g., random data 201 of FIG. 2), which client device 102 may store in a locally accessible memory or data repository. Client device 102 may also generate and store client-specific random data (e.g., random data 202 of FIG. 2), which client device 102 may transmit to resource device 112 across network 122. In certain aspects, as described above, the establishment of mutual randomness by client device 102 and resource device 112 may reduce a likelihood or replay attacks (e.g., when a malicious party monitors and attempts to replicate the initial handshake process), and may ensure the freshness of the generated and received random data (e.g., that the data is new and not previously intercepted).

In additional aspects, client device 102 may perform operations that establish mutual privacy with resource device 102 and confirm a mutual possession of the shared private cryptographic key. For example, in step 306, client device 102 may receive, from resource device 112 across network 122, a device identifier of resource device 112 encrypted using the shared private cryptographic key (e.g., device identifier data 203 of FIG. 2). Client device 102 may decrypt the received data to obtain the device identifier (e.g., to identify resource device 112), and may store the device identifier in a locally accessible memory or data repository.

Client device 102 may also encrypt a sequence of caveats from a macaroon-based local device authentication token using the shared private cryptographic key (e.g., caveat data 204 of FIG. 2), and may transmit the encrypted caveat sequence to resource device 112 across network 122 (e.g., in step 308). As described above, the local device authentication token may be specific to client device 102, and may enable resource device 112 to authenticate to client device 102 and only client device 102. Additionally, in certain aspects, the local device authentication token may include one or more caveats and an authentication key, which may include a digital signature of the caveat sequence computed based on a client-specific cryptographic key known only to client device 102 and resource device 112. As described below, resource device 112 may receive the encrypted caveat sequence, which may be decrypted and stored in local memory.

The disclosed embodiments are, however, not limited to processes that encrypt the device identifier of resource device 112 (e.g., as received by client device 102 in step 306) and/or that encrypt the sequence of caveats (e.g., by client device 102 in step 308) using local copies of the shared private cryptographic key. In other aspects, and consistent with the disclosed embodiments, client device 102 may receive the device identifier from resource device 112 across network 122 without encryption, and additionally or alternatively, client device 102 may transmit the sequence of caveats to resource device 112 across network 122 without encryption.

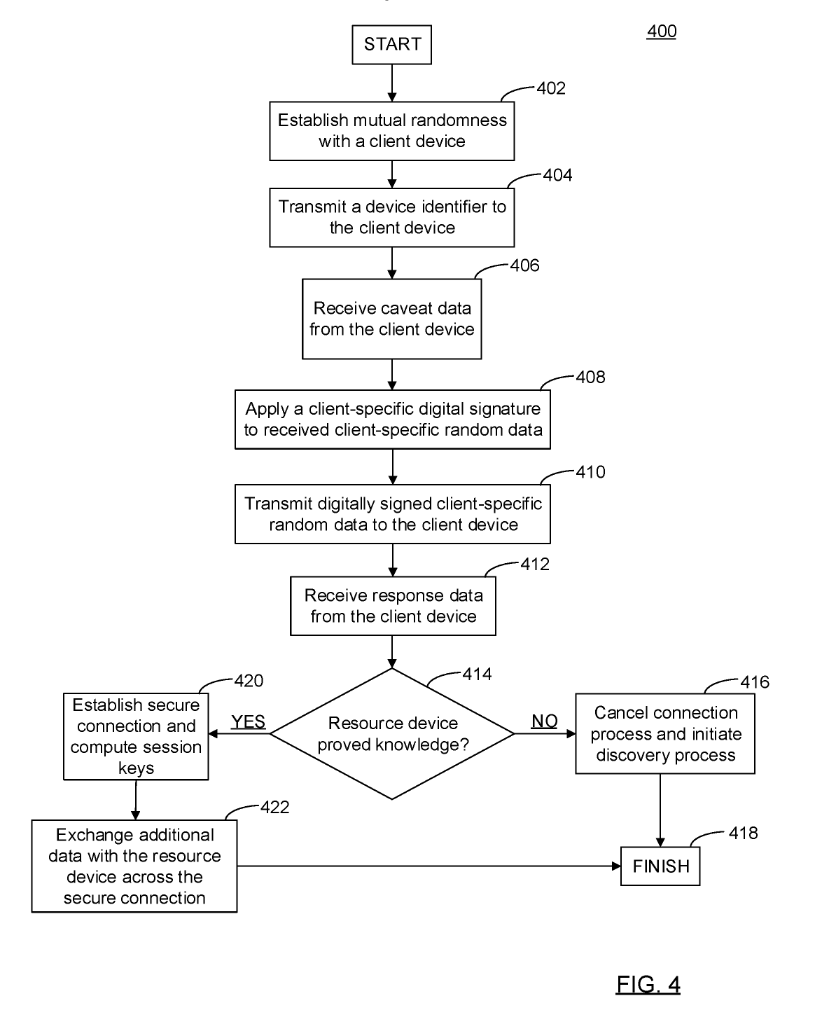

In additional aspects, and upon confirmation of the mutual possession of the shared private cryptographic key, client device 102 may perform operations to establish resource device 112's knowledge of the authentication tag of client device 102's local device authentication token and thus, its knowledge of client device 102's client-specific cryptographic key. For example, in step 310, client device 102 may receive a digitally signed copy of the client-specific random data (e.g., digitally signed random data 205 of FIG. 2) from resource device 112. As described above, client device 102 provided the client-specific random data to resource device 112 in step 304, and resource device 112 may apply a client-specific digital signature to that client-specific random data and return the digitally signed client-specific random data to client device 102 across network 122. For example, and as described below in reference to FIG. 4, resource device 112 may derive a copy of the client-specific cryptographic key based on a generated root cryptographic key and the sequence of caveats received from client device 102, and may compute the client-specific digital signature by applying a MAC algorithm to the client-specific random data.

In response to the received digital signature, client device 102 may compute a digital signature of its stored client-specific random data (e.g., as generated by client device 102) by applying the MAC algorithm to the client-specific random data and the client-specific cryptographic key (e.g., in step 312). Client device 102 may then compare the digital signature computed for the client-specific random data against the digital signature received from resource device 112 (e.g., in step 314).

If client device 102 were to determine that the computed digital signature fails to match the received digital signature (e.g., step 314; NO), client device 102 may establish that resource device 112 failed to prove its possession of the client-specific cryptographic key, and client device 102 may transmit a message indicative of a failed connection to resource device 112 (e.g., in step 316). Exemplary process 300 may then be complete in step 318.

Alternatively, if client device 102 were to detect a match between computed and received digital signatures (e.g., step 314; YES), client device 102 may establish that resource device 112 proved its possession of the client-specific cryptographic key, and client device 102 may establish a secure wireless connection with resource device 112 across network 122 and may compute a session key for communications across the secure wireless connection (e.g., in step 320). In certain aspects, client device 102 may compute the session key by applying a key derivation function to the shared private cryptographic key, the tag of the local device authentication token, and the caveat sequence, which are known and/or stored by client device 102. In an embodiment, client device 102 may also maintain the confidentiality of the generated session key.

Further, and as described above, the initial handshake phase of disclosed connection protocols may be complete upon generation of the session key, and client device 102 may exchange additional data with resource device 112 across the established secure wireless connection (e.g., in step 322). In some aspects, client device 102 may encrypt portions of the additional data using the generated session key, including data provided to resource device 112 to authenticate client device 102 and additionally or alternatively, to provide client device 102 with access to one or more functions of resource device 112 (e.g., portions of the local client authentication token). Exemplary process 300 is then complete in step 318.

FIG. 4 is a flowchart of an additional exemplary process 400 for establishing a secure and direct wireless connection between client and resource devices across a low-energy communications network, in accordance with the disclosed embodiments. In certain aspects, a resource device (e.g., resource device 112 of FIG. 1) may perform the steps of exemplary process 400, which may enable resource device 122 to establish a secure wireless connection with client device 102 across network 122 using connection protocols consistent with the disclosed embodiments.

In certain aspects, and upon discovery by client device 102 (e.g., using any of the exemplary techniques described above), client device 102 and resource device 112 may establish mutual randomness (e.g., in step 402). For example, resource device 112 may generate and store locally device-specific random data (e.g., random data 201 of FIG. 2), and transmit that device-specific random data to client device 102 across network 122. Additionally, resource device 112 may receive client-specific random data (e.g., random data 202 of FIG. 2) from client device 102, which resource device 112 may store in a locally accessible memory or data repository. As described above, the establishment of mutual randomness by client device 102 and resource device 112 may reduce a likelihood or replay attacks (e.g., when a malicious party monitors and attempts to replicate the initial handshake process), and may ensure the freshness of the generated and received random data (e.g., that the data is new and not previously intercepted).

In additional aspects, resource device 112 may also perform operations that establish mutual privacy with client device 102 and confirm a mutual possession of the shared private cryptographic key. For example, resource device 112 may encrypt a device identifier (e.g., a media access control (MAC) address, an IP address, etc.) using its local copy of the shared private cryptographic key, and resource device 112 may transmit the encrypted device identifier (e.g., device identifier data 203 of FIG. 2) across network 122 to client device 102 (e.g., in step 404). As described above, client device 102 may decrypt the encrypted device identifier data and store the device identifier in a locally accessible memory or data repository.

Resource device 112 may also receive an encrypted sequence of caveats (e.g., caveat data 204 of FIG. 2) from client device 102 (e.g., in step 406). In certain aspects, described above, client device 102 may access the sequence of caveats incorporated into the local device authentication token, and may encrypt the accessed caveat sequence prior to transmission to resource device 112. Resource device 112 may decrypt the encrypted caveat sequence and may store the identified caveat sequence within the locally accessible memory or data repository. In certain aspects, as described above, at least one of the caveats may include an identifier of the client-specific cryptographic key maintained by client device 102, which resource device 112 may extract from the decrypted sequence of caveats and store in the locally accessible memory or data repository.

The disclosed embodiments are, however, not limited to processes that encrypt the device identifier of resource device 112 (e.g., by resource device 112 in step 404)) and/or that encrypt the sequence of caveats (e.g., as received by resource device 112 in step 406) using local copies of the shared private cryptographic key. In other aspects, and consistent with the disclosed embodiments, resource device 112 may transmit the device identifier to client device 102 across network 122 without encryption, and additionally or alternatively, resource device 112 may receive the sequence of caveats from client device 102 across network 122 without encryption.

In further aspects, connection protocols consistent with the disclosed embodiments may enable resource device 112 to prove its knowledge of the client-specific cryptographic key, and thus enable client device 102 to verify an identity of resource device 112. For instance, upon establishing its possession of the shared private cryptographic key, resource device 112 may apply a client-specific digital signature to the stored client-specific random data (e.g., in step 408), and may transmit the signed client-specific random data (e.g., digitally signed random data 205) to client device 102 across network 122 (e.g., in step 410). For example, in step 410, resource device 112 may derive a copy of the client-specific cryptographic key based on a previously generated root cryptographic key (e.g., as generated during an initial device step) and the sequence of caveats received from client device 102 (e.g., and stored in locally accessible memory or data repository). In some aspects, resource device 112 may then compute the client-specific digital signature in step 408 by applying a MAC algorithm to the stored client-specific random data (e.g., as received from client device 102 in step 402) and the derived client-specific cryptographic key.

As described above in reference to FIG. 3, client device 102 may receive the signed client-specific random data, and may compute a digital signature of its stored client-specific random data by applying the MAC algorithm to its copy of the client-specific random data and the client-specific cryptographic key (e.g., in step 312 of FIG. 3). Client device 102 may also compare the digital signature computed for the client-specific random data against the digital signature received from resource device 112 (e.g., in step 314 of FIG. 3), and may transmit data indicative of an outcome of the comparison to resource device 112.

Referring back to FIG. 4, resource device 112 may receive client device 102's response to the comparison of the digital signatures (e.g., in step 412), and resource device 112 may establish whether the client-specific digital signature generated in step 408 proved its knowledge of the client-specific cryptographic key (e.g., in step 414). For example, as described above, client device 102 may determine that computed digital signature fails to match the received digital signature (i.e., that resource device 112 failed to prove its possession of the client-specific cryptographic key), and may transmit a response indicative of a failed connection attempt to resource device 112. In some instances, resource device 112 may process the received response to identify the failed connection attempt (e.g., step 414; NO), which indicates its failure to prove knowledge of the client-specific cryptographic key, and resource device 112 may cancel the connection process with client device 102 and broadcast additional advertisement data to initiate discovery processes with other devices operating across network 122 (e.g., in step 416). Exemplary process 400 is then complete in step 418.

Alternatively, the received response may indicate that resource device 112 proved its knowledge of the client-specific cryptographic key (e.g., step 414; YES), and resource device 112 may establish a secure wireless connection with client device 102 across network 122 and may compute a session key for communications across the secure wireless connection (e.g., in step 420). In certain aspects, resource device 112 may compute the session key by applying a key derivation function to the shared private cryptographic key, the tag of the local device authentication token, and the caveat sequence, which are known and/or stored by resource device 112. In an embodiment, resource device 112 may also maintain the confidentiality of the generated session key.

Further, and as described above, the initial handshake phase of disclosed connection protocols is complete upon generation of the session key, and resource device 112 may exchange additional data with client device 102 across the established secure wireless connection (e.g., in step 422). In some aspects, resource device 112 may encrypt portions of the additional exchanged data using the generated session key, including data facilitating client device 102's access to one or more functions of resource device 112 (e.g., based on portions of the local client authentication token). Exemplary process 400 is then complete in step 418.

A number of exemplary embodiments have been described. Nevertheless, it will be understood that various modifications may be made without departing from the spirit and scope of the disclosure. For example, various forms of the flows shown above may be used, with steps re-ordered, added, or removed.

Embodiments and all of the functional operations described in this specification may be implemented in digital electronic circuitry, or in computer software, firmware, or hardware, including the structures disclosed in this specification and their structural equivalents, or in combinations of one or more of them. Embodiments may be implemented as one or more computer program products, i.e., one or more modules of computer program instructions encoded on a computer-readable medium for execution by, or to control the operation of, data processing apparatus. The computer readable-medium may be a machine-readable storage device, a machine-readable storage substrate, a memory device, a composition of matter affecting a machine-readable propagated signal, or a combination of one or more of them. The computer-readable medium may be a non-transitory computer-readable medium. The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any form of programming language, including compiled or interpreted languages, and it may be deployed in any form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory may be supplemented by, or incorporated in, special purpose logic circuitry.

To provide for interaction with a user, embodiments may be implemented on a computer having a display device, e.g., a CRT (cathode ray tube), LCD (liquid crystal display) monitor, a touchscreen display, etc., for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Embodiments may be implemented in a computing system that includes a back end component, e.g., as a data server, or that includes a middleware component, e.g., an application server, or that includes a front end component, e.g., a client computer having a graphical user interface or a Web browser through which a user may interact with an implementation of the techniques disclosed, or any combination of one or more such back end, middleware, or front end components. The components of the system may be interconnected by any form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

Further, for situations in which the systems discussed here collect personal information about users, or may make use of personal information, the users may be provided with an opportunity to control whether programs or features collect personal information, e.g., information about a user's social network, social actions or activities, profession, a user's preferences, or a user's current location, or to control whether and/or how to receive content from the content server that may be more relevant to the user. In addition, certain data may be anonym ized in one or more ways before it is stored or used, so that personally identifiable information is removed. For example, a user's identity may be anonym ized so that no personally identifiable information can be determined for the user, or a user's geographic location may be generalized where location information is obtained, such as to a city, zip code, or state level, so that a particular location of a user cannot be determined. Thus, the user may have control over how information is collected about him or her and used by a content server.

While this specification contains many specifics, these should not be construed as limitations, but rather as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Thus, particular embodiments have been described. Other embodiments are within the scope of the following claims. For example, the actions recited in the claims may be performed in a different order and still achieve desirable results.

What is claimed is:

1. A computer-implemented method, comprising:
transmitting, by a client device, first random data to a resource device across a direct wireless connection;
receiving, by the client device, a first digital signature from the resource device, the first digital signature being computed by the resource device based on the first random data and a first cryptographic key, the first cryptographic key being shared between the client and resource devices;
generating, by the client device, a second digital signature based on the first random data;
determining, by the client device, that the first digital signature corresponds to the second digital signature; and
in response to the determination, and by the client device, generating a session key associated with a communications session between the client device and the resource device.

2. The method of claim 1, further comprising using the session key during the communications session to (i) encrypt data from the client device that is sent to the resource device and (ii) decrypt data from the resource device that is sent to the client device.

3. The method of claim 1, wherein generating the second digital signature comprises generating the second digital signature with the first cryptographic key;
wherein the method further comprises:
receiving, by the client device, second random data from the resource device;
generating, by the client device, a third digital signature based on the second random data using the first cryptographic key; and
transmitting, by the client device, the third digital signature to the resource device over the direct wireless connection.

4. The method of claim 1, further comprising:
encrypting token data using the first cryptographic key, the token data comprising at least a portion of an authentication token maintained by the client device; and
transmitting the encrypted token data to the resource device across the direct wireless connection.

5. The method of claim 4, wherein the token data comprises an identifier of a second cryptographic key, the second cryptographic key being specific to and maintained confidentially by the client device.

6. The method of claim 4, wherein the authentication token comprises a macaroon, the macaroon comprising one or more caveats and a corresponding key, and the token data comprises at least one of the caveats.

7. The method of claim 6, wherein the at least one of the caveats comprises an identifier of a second cryptographic key, the second cryptographic key being specific to and maintained confidentially by the client device.

8. The method of claim 6, wherein generating the session key comprises generating the session key based on the at least one caveat and the second digital signature.

9. The method of claim 4, further comprising:
generating a third cryptographic key in accordance with a key rotation schedule; and
encrypting the token data using the third cryptographic key.

10. The method of claim 4, further comprising generating a cryptographic hash of the token data and transmitting the cryptographic hash to the resource device.

11. The method of claim 10, further comprising:
determining that the encrypted token data exceeds a threshold message size; and
in response to the determination, generating the cryptographic hash of the token data.

12. The method of claim 4, wherein generating the session key comprises generating the session key based on at least a portion of the token data and the second digital signature.

13. The method of claim 1, wherein generating the second digital signature comprises calculating a message authentication code of the first random data.

14. The method of claim 1, further comprising verifying an identity of the resource device based on determining that the first digital signature matches the second digital signature.

15. A client device, comprising:
at least one processor; and
a memory storing executable instructions that, when executed by the at least one processor, causes the at least one processor to perform operations comprising:
transmitting first random data to a resource device across a direct wireless connection;
receiving a first digital signature from the resource device, the first digital signature being computed by the resource device based on the first random data and a first cryptographic key being shared between the client and resource devices;
generating a second digital signature based on the first random data;
determining that the first digital signature corresponds to the second digital signature; and
in response to the determination, generating a session key associated with a communications session between the client device and the resource device.

16. The client device of claim 15, wherein the operations further comprise:
encrypting token data using the first cryptographic key, the token data comprising at least a portion of an authentication token maintained by the client device; and
transmitting the encrypted token data to the resource device across the direct wireless connection.

17. The client device of claim 16, wherein the token data comprises an identifier of a second cryptographic key, the second cryptographic key being specific to and maintained confidentially by the client device.

18. The client device of claim 16, wherein the authentication token comprises a macaroon, the macaroon comprising one or more caveats and a corresponding key, and the token data comprises at least one of the caveats.

19. The client device of claim 18, wherein the at least one of the caveats comprises an identifier of a second cryptographic key, the second cryptographic key being specific to the client device; and
wherein at least one processor further performs the step of generating the session key based on the at least one caveat and the second digital signature.

20. A non-transitory computer-readable medium storing instructions that, when executed by at least one processor of a client device, cause the client device to perform operations comprising:
transmitting first random data to a resource device across a direct wireless connection;
receiving a first digital signature from the resource device, the first digital signature being computed by the resource device based on the first random data and a first cryptographic key, the first cryptographic key being shared between the client and resource devices;
generating a second digital signature based on the first random data;
determining that the first digital signature corresponds to the second digital signature; and
in response to the determination, generating a session key associated with a communications session between the client device and the resource device.
